(19) United States
(12) Patent Application Publication
(10) Pub. No.: US 2012/0151377 A1
(43) Pub. Date: Jun. 14, 2012

(54) ORGANIC PROJECTS

(75) Inventors: Tracy Schultz, Seattle, WA (US); Jeffrey Kohler, Redmond, WA (US); Nina Shih, Redmond, WA (US); Nino Yuniardi, Seattle, WA (US); Eli Tamanaha, Lynnwood, WA (US); Isaac Jacobsen, Bothell, WA (US); Steven Geffner, Bothell, WA (US); Peter Leonard, Seattle, WA (US); Gary Caldwell, Redmond, WA (US)

(73) Assignee: Microsoft Corporation, Redmond, WA (US)

(21) Appl. No.: 12/962,740

(22) Filed: Dec. 8, 2010

(51) Int. Cl. G06F 3/01

(52) U.S. Cl. 715/751

(57) ABSTRACT

A collaborative project management system is provided to create a project workspace linking together various work-product items including e-mails, documents and tasks based on the identification and association of related information contained in such items. A new project workspace may contain groups of documents, correspondence such as emails, instant message and web chatting, tasks, and other data types linked together by common content topics. The system may initiate a new project workspace based on information contained in an initial correspondence, such as an email conversation, by identifying items that are related to the email conversation such as tasks or documents that a user creates or shares subsequent to receipt of an email or message, and automatically inferring an association based on their contents.

### BACKGROUND

Project management systems can be useful to help gather information and related documents and work-product and organize them under common tasks. With conventional project management systems, users may manually create new projects, create task-lists, and assign documents and/or other correspondence to the project. Typically many emails and other correspondence may be exchanged among multiple users, and users must manually save emails to project files along with documents and tasks that are related to the correspondence for later use, filing, and organization. Subsequent emails on a related topic may also be individually saved to a project, though they may not be linked or associated with prior emails on the same subject, such that the conversations are not cohesive, forcing advanced searches by a user to find information contained in an email and to track conversations. Additionally, documents and tasks that are related to each other and to emails may not be linked within an organized filing system, making it difficult to keep all related information organized and accessible as part of one cohesive project.

With these conventional project management methods, it may be difficult to stay organized as to communication and work product taking place on a project, and to stay informed as to the participants involved on the project, the status of tasks related to the project, and other various activity taking place on a project.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to providing a collaborative project management system configured to create a project workspace linking together various work-product items including e-mails, documents, and tasks based on the identification and association of related information contained in such items. A new project workspace may contain groups of documents, correspondence such as emails, instant messages and web chatting, tasks, and other data types linked together by common content topics. The system may initiate a new project workspace based on information contained in an initial correspondence, such as an email conversation, by identifying items that are related to the email conversation such as tasks or documents that a user creates or shares subsequent to receipt of an email or message, and automatically inferring an association based on their contents.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates a collaboration network environment, where embodiments may be implemented;

FIG. 2 an example of a project management system environment according to embodiments;

FIG. 3 illustrates an example screenshot of a project workspace view in an email reading pane according to embodiments;

FIG. 4 illustrates an example of an established project workspace view and a way to create a new project according to embodiments;

FIG. 5 is a networked environment, where a system according to embodiments may be implemented;

FIG. 6 is a block diagram of an example project management system environment, where embodiments may be implemented;

FIG. 7 illustrates a logic flow diagram for a process of linking items in a project management system according to embodiments;

### DETAILED DESCRIPTION

As briefly described above, a collaborative project management system may help keep users organized as to items related to a common project and keep users informed as to activity occurring within a project for producing a more efficient project management system in a collaborative project environment. Such a system may be configured to create a project workspace linking together various work-product items based on the association of related information contained in such items. The system may provide a means to identify related tasks and documents that users may create and share over email or other correspondence, and to monitor and determine that an email, task, or document belongs to a specific project workspace based on an automatic inference of association from the contents of the item. The system may further create a suggested project workspace based on the inference of related contents in work-product items and may create permanent project workspaces for adding items and organizing projects. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable media.

Throughout this specification, the term “platform” may be a combination of software and hardware components for providing a project management system, which may facilitate the identification and association of related work-product items for managing and organizing projects. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

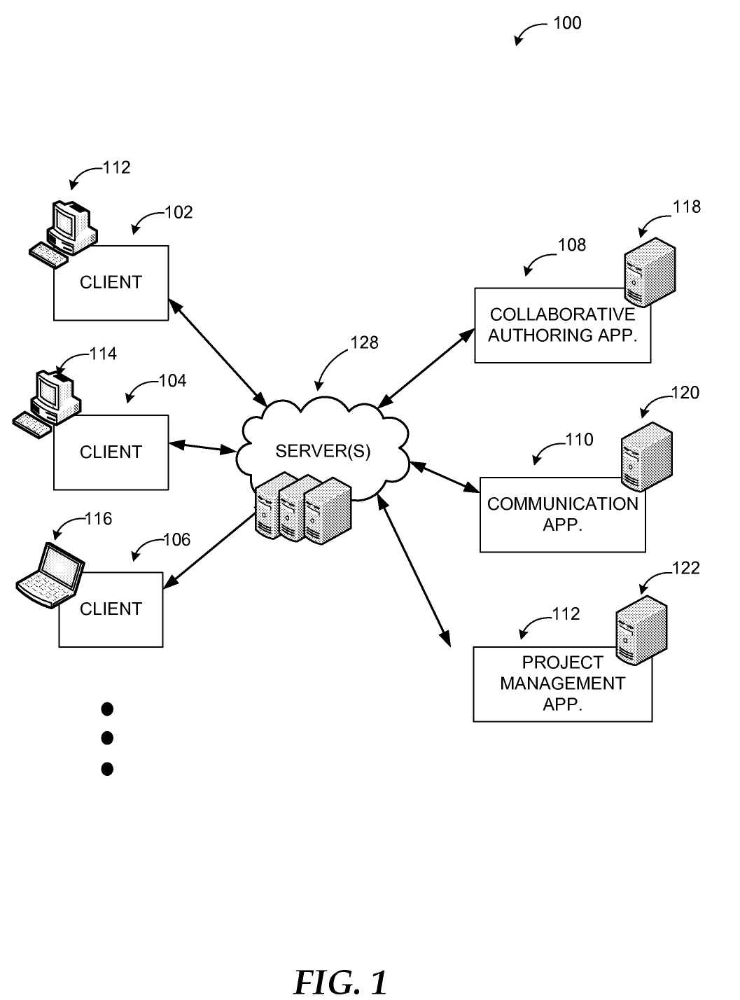

Referring to FIG. 1, conceptual diagrams 100 illustrates a networked collaborative configuration environment, where embodiments may be implemented. The computing devices and environments shown in diagram 100 are for illustration purposes. Embodiments may be implemented in various local, networked, and similar computing environments employing a variety of computing devices and systems.

Diagram 100 demonstrates a collaborative environment in which a project management system may coordinate with various applications to monitor communication and work product from one or more clients 102, 104, 106, and suggest and/or create project workspaces. The project management system may communicate with servers 128 to allow collaboration by a number of clients 102, 104, 106 providing a centralized system for organizing and managing projects. Clients 102, 104, 106 may exchange emails, instant messages, web chats, application sharing sessions, documents, and other work-product applications produced on computing devices 112, 114, 116 in a collaborative environment using collaborative authoring application(s) 108 and communication application(s) 110. The project management system allows clients 102, 104, 106 to be collaborative on projects through the implementation of collaborative authoring application(s) 108, and may allow for real-time editing of documents and tasks, and allows for easy management of workflow within a project. Computing devices 112, 114, 116 may include any computing device including, but not limited to, desktop computers, laptop computers, servers, handheld computers, vehicle mount computers, smart phones, and comparable devices.

Applications such as collaborative authoring application(s) 108, communication application(s) 110, and a project management application 112 may be on a same server 128 or may be on separate servers 118, 120, 122, and the servers may be centralized in one location or may be distributed as hosted services. Collaborative authoring application(s) 108 may be any application capable of producing word processing documents, spreadsheet documents, presentation documents, and tasks, such that a multitude of users may have access to the produced documents for viewing and editing. The configuration for a project management system is not limited to parameters of FIG. 1. A user may interact with the applications through their client application (e.g. a browsing application) executed on computing devices 114, 116, and 120. The networked environment may include communications between computing devices 114, 116, 120 and servers 128 over one or more networks, which may include enterprise networks, cloud-based networks, combinations of those two, and similar ones.

The example systems in FIG. 1 have been described with specific servers, client devices, applications, and interactions. Embodiments are not limited to systems according to these example configurations. A platform providing a project management system for linking related documents under a common project workspace in a collaborative environment may be implemented in configurations employing fewer or additional components and performing other tasks. Furthermore, specific protocols and/or interfaces may be implemented in a similar manner using the principles described herein.

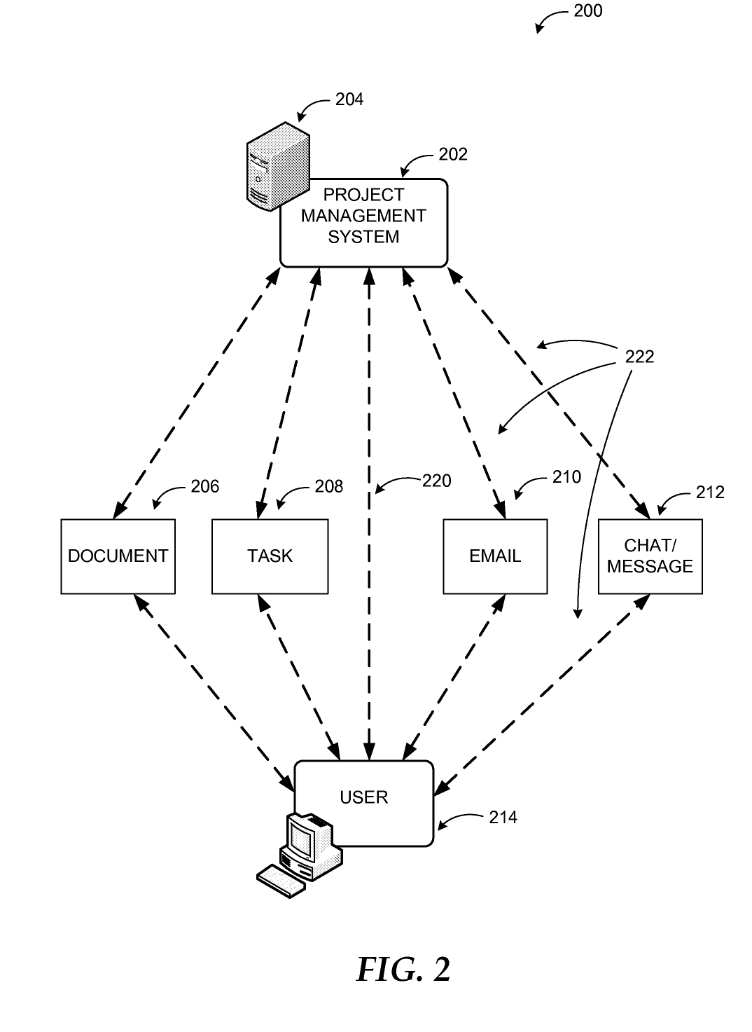

Diagram 200 of FIG. 2 demonstrates a project management system in a collaborative environment in which the project management system 202 executed on a server 204 may monitor user produced work-product items such as emails 210, chats, messaging 212, documents 206, and tasks 208, and provides a centralized project workspace for organizing and managing the work-product items by grouping the items by related topics. The project management system 202 is a system configured to link work-product items under a common project workspace in order to provide a collaborative work environment. Within a collaborative environment, all work-product may be unified under a common project for ease of management and organization and for staying updated on activity taking place within a project. The project management system 202 provides a central location or collaborative environment so that activity within a project is accessible to the users working on the project, and the project items and the contents can be shared and viewed by the users associated with the project. The project management system may allow a user 214 to create a project using a project management system independently (220) to define a project and assign tasks and items to the project, or the project management system may run concurrently with communication, word processing, spreadsheet, web, presentation, and collaborative authoring applications (222) to monitor work-product items produced using such applications and identify related contents of such items.

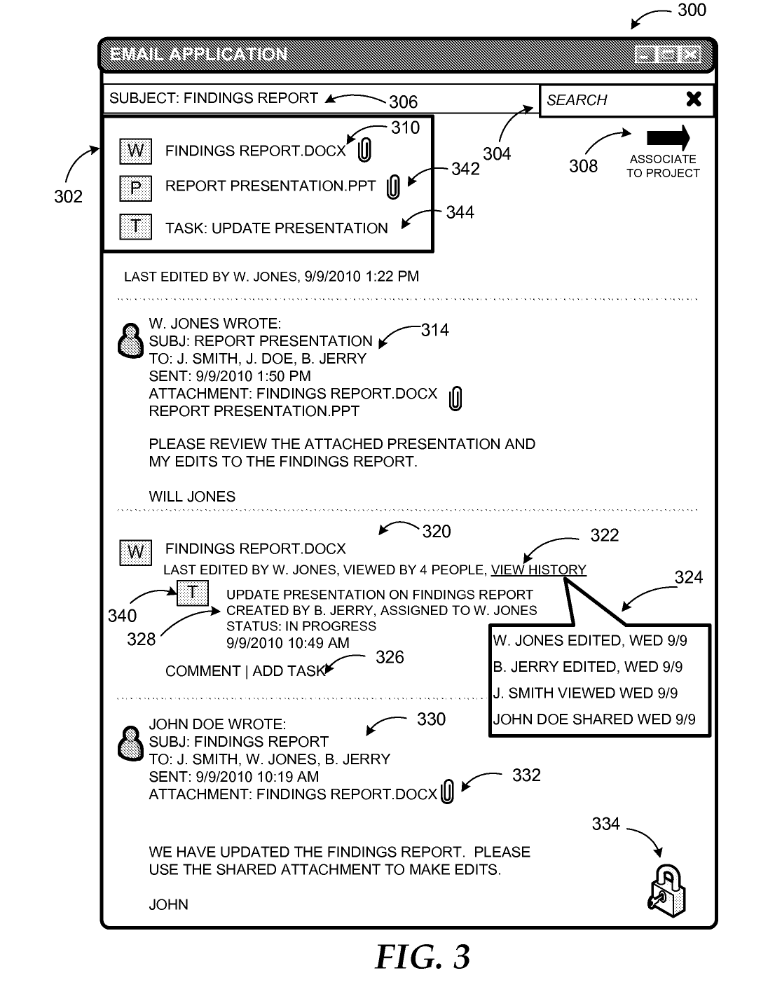

FIG. 3 illustrates a screenshot of an example project workspace 300 displayed in a communication application reading pane over a user interface. The project workspace 300 displayed over the user interface shown in screenshot 300 is for illustration purposes only. According to one embodiment, a new project workspace 300 may be initiated by the project management system when a user begins correspondence such as an email, an instant message, or chat to another user(s). The project management system may monitor user correspondence (e.g. email), and when an initial correspondence 330 is generated by a user, the system may identify the contents within the correspondence and recognize subsequent work-product items, including but not limited to emails, documents 310 and/or tasks 340, that are shared as attachments in an email 332, or created as a result of the email by one or more recipients of the correspondence.

According to other embodiments, the system may automatically infer a relationship between the email 330, task 340, document 332, and group these work-product items under a suggested or provisional project workspace 300. The project management system may suggest a name for the provisional project workspace 306 based on the subject of the email or the inferred contents of the initial correspondence. The project management system may be configured to recognize attached documents 332 and tasks within an email correspondence and may automatically determine that the attached documents 332 and subsequently created tasks are related to the email, and may associate those items with the provisional project workspace 300.

In a further embodiment, the project management system may continue to monitor the initial correspondence 330 as well as the subsequent work-product (e.g. document 320 or emails 314 and 330) for updated activity on the various work-product items in order to keep an accurate history of the activity taking place in the provisional project workspace. The project management system may also continue to monitor other correspondence for related content or references to related information or work-product. The system may infer an association based on content references and may link the other correspondence under the same provisional project workspace 300. The system may also be configured to allow a user to associate an item to a project 308, such that when a user opens a document, task, or correspondence, the user may view a project association control 308, which the user may select to link the current item to a project workspace. A system according to some embodiments may be capable of recognizing if the body of an email contains a hyperlink to a document (or contents of a document having a link to another document). The system may detect such a hyperlink and relate the email and the document (or the two documents) to each other providing further enhanced context to the project.

As demonstrated in FIG. 3, the system may present information to a user about the group of items included in a provisional project workspace 300 in the reading view of an email or email conversation. The provisional project workspace 300 may be a suggested group of work-product items that the system has inferred are related to an initial email conversation 330 or other correspondence. In this correspondence or email conversation view, the associated items are displayed as part of the email conversation, such that a user is able to view the original email 330 and see other related work-product such as documents 310, 342 and tasks 340 that were created or edited subsequent to the initial email 330. Additionally, the system may provide relevant information 328 about each of the related items to give a user more details about each of the items, such as document and task activity.

The system may display activity information 328 on a document or task including but not limited to when edits were made and by which user, how many times a document has been viewed and by which users, who creates a task, when a task is created, the status of tasks, assignment of tasks, and subsequent email conversations. According to some embodiments, the system may provide a summary view of activity (such as document 320 or email 314) on each related item and may filter out earlier detailed activity, such that only the most recent actions action or edit activity on a document or the owner and status of a task are shown (e.g., 328). The system may further provide a more detailed view 324 on demand by a user by selecting, for example, a view history option 322 in an expanded form or pop-up view pane 324. According to further embodiments, the related items may be displayed in order of most recent activity such that the most recent item is shown at the top of an email view, and the earliest edited item is shown near the bottom. In other embodiments, the related items may be displayed chronologically, reverse chronologically, according to hierarchy of relevancy or grouped by type of item or by user. The system may allow user selection of the display view so that a user may change the display view or sort the items according to the user's preference of display view. The system may provide a search capability 304 so that a user may search the correspondence for particular information and may jump to a desired item in the conversation.

In some example implementations, the system may display the items in the provisional project workspace in a project “well” section 302, which is a separate section included in the correspondence or email conversation. The well section 302 may display work-product items 310 that are related to the current email conversation. The work-product items may be directly or indirectly related to the correspondence, such as documents 310, 342 or task 344 that was created in response to a received email. For example, a directly related item may be a document 342 that was included as an attachment and an indirect item 344 may be a task that a user creates based on the attached document.

In addition to providing a useful overview of the related items that the system has recognized as related to the initial correspondence and included in the provisional project workspace, well section 302 may include additional information about the items providing more context and history of activity to a user.

In other example implementations, the system may be configured to provide permission settings 334 such that a user or users may define who may view an email conversation or items related to an email conversation such as documents or tasks. Each item may have different permissions and each user who initiates a correspondence may determine the permission settings. For example, the system may prompt a user to set permissions when a new provisional workspace is created, and a user may independently set and change permissions without being prompted.

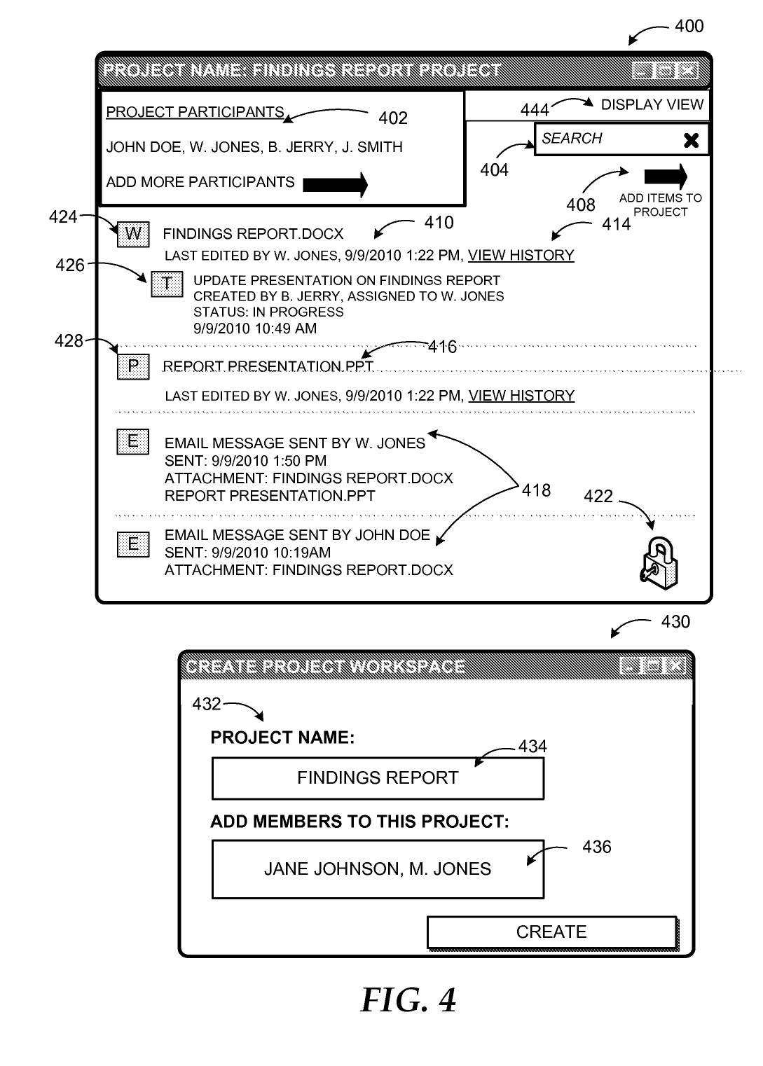

FIG. 4 illustrates a screenshot of another example implementation of a project management system according to embodiments. Screenshot 400 illustrates an established project workspace where all of the documents, tasks, and correspondence (410) associated to a common project are displayed. As illustrated in FIG. 4, a new established project workspace may be created from the initiation of any work-product item including emails 418, documents 424, tasks 426, or presentations 428 when a user manually creates a new project and associates that item to the new project, accepts a suggested provisional project workspace to associate the item to, or associates the work-product item to an existing project workspace.

According to some embodiments, when a user opens a document, task, or correspondence, the user may view a project association control 408, which the user may select to link the current item to a project workspace. If a provisional project workspace has been suggested, the user may accept the suggested linking and add the current item to the workspace, transitioning the provisional workspace into an established workspace.

A user may prefer to create a new project from a current work-product item, and when the user selects this option, the system may allow the user to list users who should be participants of the new project 434. The system may provide user interface 430 providing suggested project name 432, which the user may accept or rename the new project using textbox 434. User interface 430 may also automatically populate a list of recommended participants 436 and may give a user the ability to modify the suggested list of participants. For example, when user 1 creates a new project based on an email sent to users 2 and 3, the system may suggest that users 2 and 3 be included as participants on the project, as well as user 1 who originally sent the email. When a user is added to a project, the user may receive a notification by email or other correspondence such as a pop-up view pane or alarm indicating to the user that the user may view a new project workspace.

According to further embodiments, project permissions 422 may be set by one or more users or may be automatically set based on the individual permission settings of each item. For example, documents and tasks 424, 426 directly associated to a project workspace may permit access to all participants on a project. Email conversations 418 that are associated to a project may permit all participants of a project to view the email when it is associated to the project, and the system may allow permissions 422 to be set such that only senders and recipients of the email may view the email conversation. The permissions and privacy settings may be altered and changed by original user creators of each item.

According to yet other embodiments, a library view may be provided such that correspondence, documents, and tasks that are associated with a project are displayed to a user. The library view may display the items in a variety of views such as chronologically, reverse chronologically, according to hierarchy of relevancy or grouped by type of item, or grouped by user, and the system may allow user selection of the view 444 so that a user may change the display view or sort the items according to the user's preference of display view similar to the email conversation view. The library view may contain summary information about each item in the project list; or in alternative embodiment the library view may contain a range of detailed information relating to each item including a detailed history of each item and information relating to users that have read, accessed, and edited documents, and task owners, assignments and status.

The system may also provide a search capability 404 so that a user may search the project list for particular information or particular items and may jump to a desired item in the project list. Additionally, the system may allow a user to modify a project list in the project view such as deleting an item from view or rearranging the presentation of the view. A user may be able to dissociate an item from a project by deleting the item from the library view; and in another embodiment, the system may provide an option to remove an item from the system completely or to re-associate an item to a different project.

In some example implementations, the system may provide a project feed view which displays all of the projects that are active in the system and may display a summary view or a detailed view of related items associated with each project. The project feed view may provide summary information about each project in the list such as showing documents or tasks associated with the project to provide a context of the project to a user. In alternative embodiments, the system may display a range and variety of detailed information on each project and each item within a project such that different details are shown to the user as the user deems helpful. For example, each project feed may display the documents 424, 428 relating to it or the task assigned to it, or the feed may display only the most recent activity to have taken place on a project. Alternatively, each project feed may display the users participating on the project 402. The system may also provide a user with the capability to select which information about each project is displayed and to change the display accordingly.

The examples in FIG. 2 through 4 have been described with specific user interface elements, configurations, and presentations. Embodiments are not limited to systems according to these example configurations. A project management system may be implemented in configurations using other types of user interface elements, presentations, and configurations in a similar manner using the principles described herein.

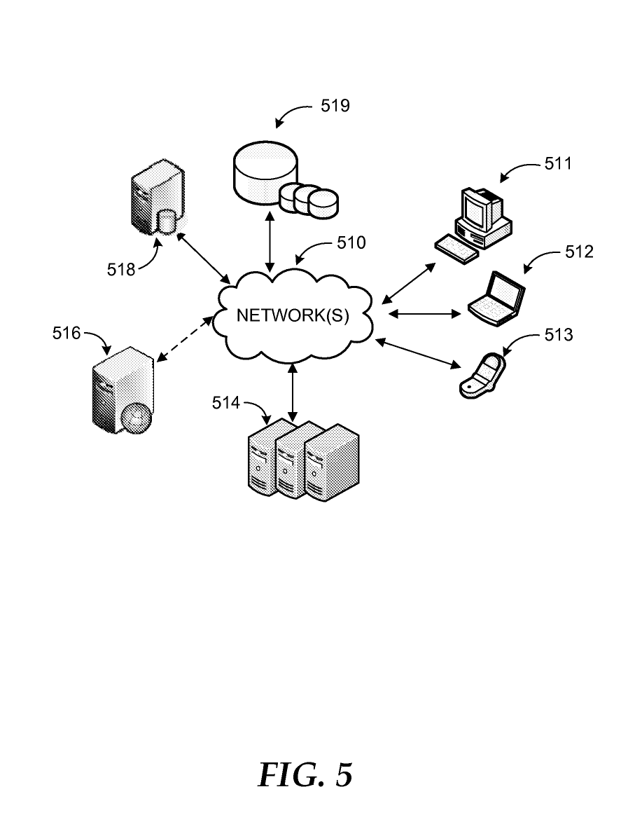

FIG. 5 is an example networked environment, where embodiments may be implemented. A system providing a project management system linking documents, tasks, and correspondence under a common project workspace may be implemented via software executed over one or more servers 514 such as a hosted service. The platform may communicate with client applications on individual computing devices such as a smart phone 513, a laptop computer 512, or desktop computer 511 (client devices') through network(s) 510.

Client applications executed on any of the client devices 511-513 may facilitate communications via application(s) executed by servers 514, or on individual server 516. A project management application executed on one of the servers may facilitate the identification of related content and association of related documents to a common project workspace. The application may automatically infer an association of work-product items and email conversations based on the identification of related contents, and may suggest linking and associating of documents and tasks associated with an email conversation to a common workspace. The configuration application may retrieve relevant data from data store(s) 519 directly or through database server 518, and provide requested services (e.g. document editing) to the user(s) through client devices 511-513.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to implement a platform providing a project management system for linking related work-product items under a common project workspace. Furthermore, the networked environments discussed in FIG. 5 are for illustration purposes only. Embodiments are not limited to the example applications, modules, or processes.

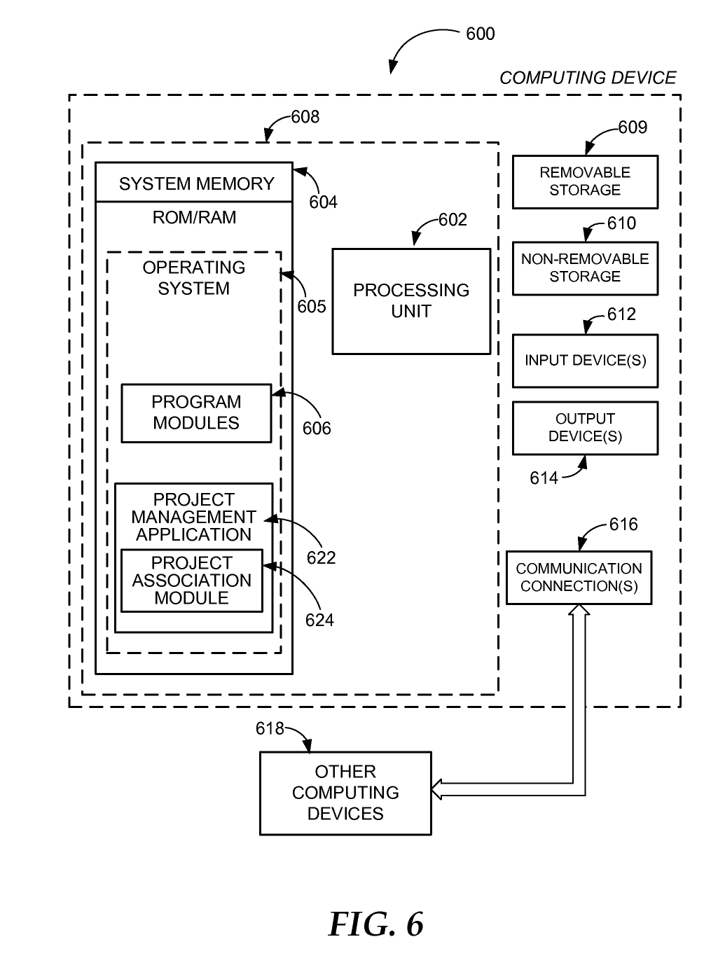

FIG. 6 and the associated discussion are intended to provide a brief, general description of a suitable computing environment in which embodiments may be implemented. With reference to FIG. 6, a block diagram of an example computing operating environment for an application according to embodiments is illustrated, such as computing device 600. In a basic configuration, computing device 600 may be any computing device executing an application capable of linking and associating related work-product items under a common project workspace according to embodiments and include at least one processing unit 602 and system memory 604. Computing device 600 may also include a plurality of processing units that cooperate in executing programs. Depending on the exact configuration and type of computing device, the system memory 604 may be volatile (such as RAM), non-volatile (such as ROM, flash memory, etc.) or some combination of the two. System memory 604 typically includes an operating system 605 suitable for controlling the operation of the platform, such as the WINDOWS® operating systems from MICROSOFT CORPORATION of Redmond, Wash. The system memory 604 may also include one or more software applications such as program modules 606, project management application 622, and project association module 624.

Project management application 622 may enable the system to monitor correspondence between users and the work-product produced by one or more users in a collaborative environment and to group work-product items into a common project workspace by automatically linking the items based on the association of related content. Through a user interface controlled by project association module 624, project management application 622 may display a project workspace containing linked items associated with an email conversation, or may enable a user to create a project workspace in order to manage documents and correspondence related to a common project topic. Application 622 and project association module 624 may be separate application or integrated modules of a hosted service. This basic configuration is illustrated in FIG. 6 by those components within dashed line 608.

Computing device 600 may have additional features or functionality. For example, the computing device 600 may also include additional data storage devices (removable and/or non-removable) such as, for example, magnetic disks, optical disks, or tape. Such additional storage is illustrated in FIG. 6 by removable storage 609 and non-removable storage 610. Computer readable storage media may include volatile and nonvolatile, removable and non-removable media implemented in any method or technology for storage of information, such as computer readable instructions, data structures, program modules, or other data. System memory 604, removable storage 609 and non-removable storage 610 are all examples of computer readable storage media. Computer readable storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and which can be accessed by computing device 600. Any such computer readable storage media may be part of computing device 600. Computing device 600 may also have input device(s) 612 such as keyboard, mouse, pen, voice input device, touch input device, and comparable input devices. Output device(s) 614 such as a display, speakers, printer, and other types of output devices may also be included. These devices are well known in the art and need not be discussed at length here.

Computing device 600 may also contain communication connections 616 that allow the device to communicate with other devices 618, such as over a wired or wireless network in a distributed computing environment, a satellite link, a cellular link, a short range network, and comparable mechanisms. Other devices 618 may include computer device(s) that execute communication applications, web servers, and comparable devices. Communication connection(s) 616 is one example of communication media. Communication media can include therein computer readable instructions, data structures, program modules, or other data. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

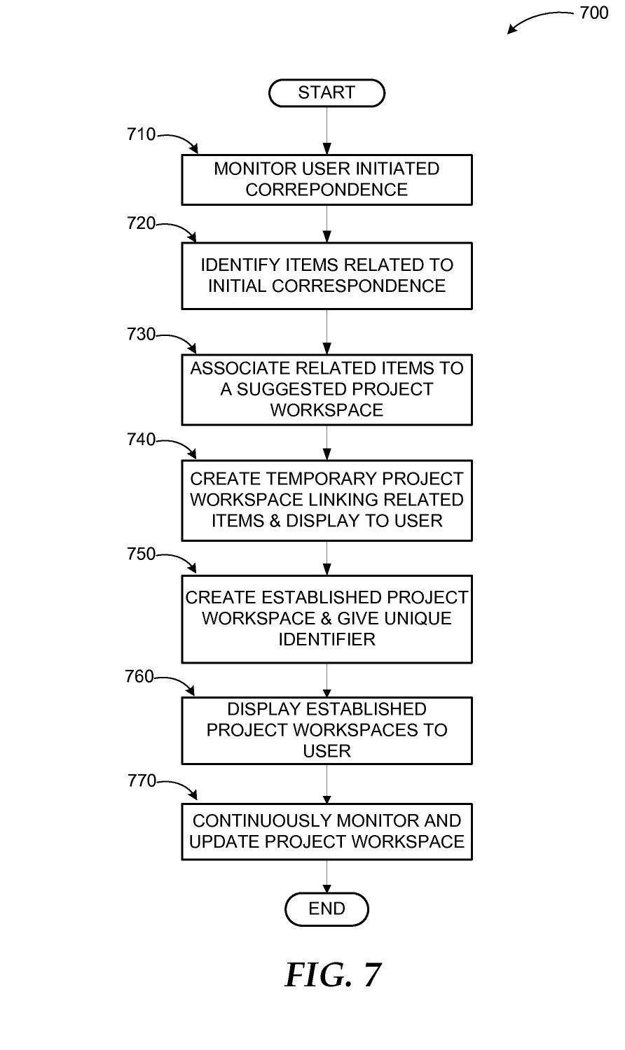

FIG. 7 illustrates a logic flow diagram for process 700 of providing a common project workspace for grouping related documents, tasks, and correspondence under a common project topic. Process 700 may be implemented on a server or other computing device.

Process 700 begins with operation 710, where the project management system recognizes and monitors user initiated correspondence such as emails, web chatting and other forms of messaging. At operation 720, the system identifies items that are related to the initial correspondence such as documents that are attached to or referenced in the initial email or message or documents or tasks that are created in response to the receipt of the message. Additionally at operation 720, the system continuously monitors subsequent correspondence for references to the initial correspondence or initially identified related items and infers an association between the items based on the content reference. At operation 730, the system associates the related items to the initial email correspondence under a common topic and links all related items to the initial email.

At operation 740, the system creates a provisional or suggested project workspace linking the items under a common project topic, and subsequently, the system may display the suggested provisional project workspace as a list of related items to a user. In some example implementations, the project may be started from an email or user indication. At operation 750, the system may create a permanent or established project workspace based on the acceptance and confirmation of the suggested provisional project workspace. The system may give the established project workspace a unique identifier or may use a unique name input by a user. At operation 750, the system creates an established project workspace along with associated views, which is displayed to a user at operation 760. At operation 770, the system continues to monitor work-product items for related content and associates related items to established project work-spaces for continuous grouping and project association. According to some embodiments, people who are part of a project may be notified when project content changes. For example, if someone reads or modifies an email or a document that is associated with a project, other project members may receive a notification that this occurred.

The operations included in process 700 are for illustration purposes. A project management system for grouping related items under a common project workspace may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to be executed at least in part in a computing device for providing an organic project, the method comprising:
monitoring correspondence between one or more users;
identifying items that are related to the correspondence;
inferring an association of related content to the correspondence;
upon inferring an association of the related content to the correspondence, linking related content items to the correspondence in a provisional project workspace;
displaying the related content items in the provisional project workspace employing a correspondence view; and
displaying history and activity information associated with the related items, wherein the history and activity information includes at least one from a set of: edit records, viewing records, and timestamps.

2. The method of claim 1, further comprising:
enabling a user to create an established project workspace by assigning at least one from a set of: documents, tasks, and correspondence to a new project;
upon receiving a user confirmation, creating the established project workspace grouping related work-product items under a common project name; and
displaying the established project workspace employing a project workspace view.

3. The method of claim 2, further comprising:
enabling the user to associate at least one from a set of: documents, tasks, and correspondence with a previously established project workspace.

4. The method of claim 1, further comprising:
displaying in activity information associated with the related content items in one of a full detail view and a summary view.

5. The method of claim 1, wherein the items identified as related to the correspondence include at least one from a set of: a document and a task shared as attachment in an email, a document and a task created as a result of an email, and a document and a task contents of which reference related content to the initial correspondence.

6. The method of claim 1, wherein creating the established workspace comprises transitioning a provisional project workspace to the established project workspace by enabling a user to accept at least one from a set of suggested project association, project participants, and project name.

7. The method of claim 1, further comprising:
displaying linked items based on one of: item type, associated user, relevancy, and order of activity associated with an item.

8. The method of claim 1, further comprising:
providing a search capability enabling a user to search the project workspace by keyword.

9. The method of claim 1, further comprising:
enabling a user to define security options and user permissions for one or more of the items in the project workspace.

10. The method of claim 1, further comprising:
displaying a project outline view listing a summary of at least one from a set of: documents, tasks, users, and correspondence grouped in the project workspace.

11. A server for providing an organic project, comprising:
a memory storing instructions;
a processor coupled to the memory, the processor executing at least one project management application in conjunction with instructions stored in the memory, wherein the project management application is configured to:
monitor correspondence between one or more users;
identify items that are related to the correspondence;
infer an association of related content to the correspondence;
link the related content to the correspondence under a provisional project workspace;
display the related content in the provisional project workspace in a correspondence view;
display history and activity information associated with the related content;
in response to a user confirmation, create an established project workspace grouping related work-product items under a common project name in a central location by one of converting the provisional project workspace and enabling the user to create a new project; and
display the established project workspace in a project workspace view.

12. The server of claim 11, wherein the project management application is further configured to suggest a name for the provisional project workspace based on one of a subject line and content of the correspondence.

13. The server of claim 11, wherein the work-product items include at least one from a set of: a document, a task, an email correspondence, an instant message correspondence, and a chat session.

14. The server of claim 11, wherein the project management application is further configured to provide a project feed view displaying current established project workspaces and project information that includes at least one from a set of: a date of creation, a recent activity, a linked document, and a project participant.

15. The server of claim 11, wherein the project management application is further configured to enable a user to set security settings for each item within the established project workspace.

16. The server of claim 15, wherein the security settings are alterable by an original creator of a correspondence associated with each item.

17. A computer-readable storage medium with instructions stored thereon for providing organic projects, the instructions comprising:
monitoring correspondence between one or more users;
identifying items that are related to the correspondence;
inferring an association of related content to the correspondence;
displaying the related content in a provisional project workspace employing a correspondence view;
recognizing a link to an item within the correspondence;
automatically associating the linked item with the provisional project workspace;
in response to a user confirmation, creating an established project workspace grouping related content and the linked item under a common project name in a central location by one of converting the provisional project workspace and enabling the user to create a new project; and
displaying the established project workspace in a project workspace view, wherein the project workspace view includes activity information associated with each item that includes at least one from a set of: when the item was edited, how many times the item has been viewed, by whom the item has been viewed, by whom the item has been created, when the item has been created, a status of the item, and related items.

18. The computer-readable medium of claim 17, wherein the instructions further comprise:
upon addition of a user to a project, transmitting a notification to the added user, wherein the notification includes one of an email message, an instant message, and a pop-up view pane.

19. The computer-readable medium of claim 17, wherein the instructions further comprise:
presenting a library view displaying project items in one of: a chronologic order, a reverse chronologic order, a hierarchy of relevancy, an order based item type, and a user defined order.

20. The computer-readable medium of claim 19, wherein the library view further includes summary information associated with each project item providing at least one from a set of: a history of each item, users that have created each item, users that have read each item, users that have edited each item, users assigned to tasks, a status of each item.
